(19) United States
(12) Patent Application Publication
(10) Pub. No.: US 2016/0110922 A1
(43) Pub. Date: Apr. 21, 2016

(54) METHOD AND SYSTEM FOR ENHANCING COMMUNICATION BY USING AUGMENTED REALITY

(71) Applicant: Tal Michael HARING, Ramat Hasharon (IL)

(72) Inventor: Tal Michael HARING, Ramat Hasharon (IL)

(21) Appl. No.: 14/882,474

(22) Filed: Oct. 14, 2015

Related U.S. Application Data
(60) Provisional application No. 62/064,511, filed on Oct. 16, 2014.

(51) Int. Cl. G06T 19/00; G06T 13/40; H04N 7/15; G06T 13/20

(52) U.S. Cl. CPC G06T 19/006; G06T 13/205; G06T 13/40; H04N 7/157

(57) ABSTRACT

The subject matter discloses a method for enhancing communication, comprising: generating an avatar according to metadata that is received from a remote computer device; augmenting the avatar in a live video stream captured by the computer device and instructing an audio unit of the computer device to play an audio stream; wherein the audio stream is received from the remote computer device; wherein the generating, the augmenting and the instructing being within a voice communication session with the remote computer device

### FIELD OF THE INVENTION

The present disclosure relates to communication between computer devices in general, and to enhancing communication with augmented, reality in particular.

### BACKGROUND OF THE INVENTION

Augmented reality (AR) is a live direct or indirect view of a physical, real-world environment whose elements are augmented (or supplemented) by computer-generated sensory input such as sound, video, graphics or GPS data. The technology functions by enhancing one's current perception of reality. By contrast, virtual reality replaces the real world with a simulated one. Augmentation is conventionally in real-time and in semantic context with environmental elements, such as sports scores on TV during a match. With the help of advanced AR technology (e.g. adding computer vision and object recognition), the information about the surrounding real world of the user becomes interactive and digitally manipulated. Artificial information about the environment and its objects can be overlaid on the real world.

### SUMMARY OF THE INVENTION

The term voice communication session refers herein to communication session over the internet, which includes at least audio stream. The audio stream typically includes a recording of the audio of the user. The term voice communication refers to an interactive interchange of data between two or more computer devices, which is set up or established at a certain point in time, and then torn down at some later point.

The term voice message refers herein to an internet communication message that is sent to one or more users and wherein the message includes at least an audio stream. The audio stream typically includes a recording of the audio of the user.

Embodiments of the invention disclose a system and a method for enhancing communication by using augmented reality. According to some embodiments, voice communication sessions and voice messages are enhanced by augmenting 3D avatars in a live video stream that is captured during the communication session. According to some embodiments, the 3D avatars represent the participants of the voice communication session such that a computer device of each participant may display the 3D avatars of the other users that participate in the voice session. The 3D avatars of the other users that participate in the voice session are augmented in the environment in which the computer device is currently located; thus enhancing the feeling of having a live conversation, interaction and presence between the users. In some embodiment, the avatar is selected by the user and is enhanced or customized by the user. In some embodiments, the avatar may be human formed, and is initially augmented parallel to the floor or ground of the surroundings where the device is held. In some embodiments, the enhancement or customization of the 3D avatar includes changes in the measurements of the mesh of the 3D model according to an inputted image and texture projection of the same image over the 3D model. For example, a real image of the face or the body of the user may enhance the avatar to resemble the user's skin texture, color, head and face parts sizes and proportions. In some embodiment, the avatar's body is remotely controlled by the user that has generated the avatar by sending commands of body animations stored in all devices, to make the 3D avatar, for example, walk, jump, run in circles or simply move or act as much and as how as the user wishes to.

In one example, a user may create a three dimensional avatar that resembles himself, choose a movement or a sequence of animations for the avatar's body, record an audio message and send a voice message with the recorded data to one or more remote devices of one or more other users. The remote devices receive the recorded data and recorded audio, generate the sending user's avatar according to the recorded data, augment this newly generated avatar in the receiving device's current surroundings and play the audio message while moving the avatar's body according to the recorded data; thus mimicking the presence of the sending user in the receiving user's current surrounding. In another example, the users participate in a voice communication session in which the mimics of the avatar's head and face are changed according to the audio stream or according to metadata that is sent from the computer device of the user to the computer devices of the other participants. The metadata describes the real changes of the head and face mimics of the user during the voice call. In some embodiments, the avatar's body is remotely controlled by the creator of the avatar during the voice communication session with various animations and commands.

One technical problem dealt with by the present disclosure is the performance of a video call. In a typical video conferencing system the audio and video of the participants in the conformance is streamed in real time. The video is typically compressed and sent through an internet connection to other devices. If the internet connection is slow on either device, the video that is displayed is typically disturbed and includes pauses.

One technical solution to a voice communication session is to not transmit a live video recording of each user, but, instead, to transmit metadata of an avatar that resembles the user. Such metadata may be used by each of the computer devices of the other participants for regenerating the avatar and for augmenting the avatar in a video stream that is captured locally. According to some embodiments the data objects that are used for building the avatar are installed in each computer device that participate in the voice communication session such that the metadata that is sent is sufficient for regenerating the avatars. According to some embodiments, an image of the user may also be sent to all the users that participant in the session such that each avatar may be personalized to resemble the user that has generated this avatar. Additionally the face expression of the avatar may be changed in accordance with the audio recording of the user; thus, providing, with less communication resources comparing to video call, an experience of the presence of all the participants in the surroundings of each participant.

One exemplary embodiment of the disclosed subject matter is a method for enhancing communication, comprising: at a first computer device having at least one processor and memory: generating an avatar according to metadata; the metadata being received from a second computer device via the internet; augmenting the avatar in a live video stream; the live video stream being captured by the first computer device; and instructing an audio unit of the first computer device to play an audio stream; wherein the audio stream being received from the second computer device via the internet; wherein the audio stream comprises a recording of a user of the second computer device; wherein the generating, the augmenting and the instructing being within a voice communication session between the first computer device and the second computer device or wherein the generating, the augmenting and the instructing being as a result of receiving a voice message from the second computer device.

According to some embodiments, the first computer device and the second computer device being a mobile device or a Wearable Computer Device.

According to some embodiments, the method of further comprises amending facial expression of said avatar in accordance with the audio stream to thereby reflect facial expression of said user.

According to some embodiments, the method further comprises receiving second metadata and amending facial expression of the avatar in accordance with said second metadata wherein the second metadata comprises facials expression of said user of the second computer device; the facial expression being captured by the second computer device; thereby reflecting facial expression of said user.

According to some embodiments the avatar being a three dimensional avatar and the method further comprising receiving a two dimensional image from said second computer device and wherein said generating said avatar comprises embedding the two dimensional image in the avatar. According to some embodiments, the two dimensional image being an image of a user of the second computer device; thereby reflecting the image of the user in avatar.

One other exemplary embodiment of the disclosed subject matter is a method for enhancing communication, comprising: at a first computer device having at least one processor and memory: generating an avatar according to metadata; the metadata being received from a second computer device via the internet; instructing an audio unit of the first computer device to play an audio stream; the audio stream being a recording of a user of the second computer device; the audio stream being received via the internet from the second computer device; and amending facial expression of the avatar in accordance with the audio stream, or amending facial expression of the avatar in accordance with second metadata, the second metadata being received from the second computer device via the internet, the second metadata comprises facials expression of a user of the second computer device during the recording; the facial expression being captured by the second computer device; wherein the generating, the instructing and the amending being within a voice communication session between the first computer device and the second computer device or wherein the generating, the instructing and the amending being as a result of receiving a voice message from said second computer device.

According to some embodiments the voice communication session and the voice message excluding a video stream.

According to some embodiments, the method further comprises manipulating said avatar within the communication session; wherein the manipulating being in accordance with instructions received from the second computer device within the communication session.

According to some embodiments, the instructions being related to body movements of said avatar.

One other exemplary embodiment of the disclosed subject matter is a non-transitory computer-readable storage medium storing instructions, the instructions when executed by a processor in a social networking system, causes the processor to:

generating an avatar according to metadata; the metadata being received from a second computer device via the internet; augmenting the avatar in a live video stream; the live video stream being captured by the first computer device; and instructing an audio unit of the first computer device to play an audio stream; wherein the audio stream being received from the second computer device via the internet; wherein the audio stream comprises a recording of a user of the second computer device; wherein the generating, the augmenting and the instructing being within a voice communication session between the first computer device and the second computer device or wherein the generating, the augmenting and the instructing being as a result of receiving a voice message from the second computer device.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for enhancing communication, in accordance with some exemplary embodiments of the subject matter;

FIG. 2 shows a flowchart of a method for enhancing communication, in accordance with some exemplary embodiments of the subject matter;

FIG. 3 shows a flowchart of a scenario for enhancing a voice message, in accordance with some exemplary embodiments of the disclosed subject matter;

FIGS. 4A and 4B show a flowchart of a scenario for enhancing a voice call, in accordance with some exemplary embodiments of the disclosed subject matter; and

FIGS. 5A and 5B show an exemplary screen capture of an enhanced voice communication session in accordance with some exemplary embodiments of the disclosed subject matter.

### DETAILED DESCRIPTION

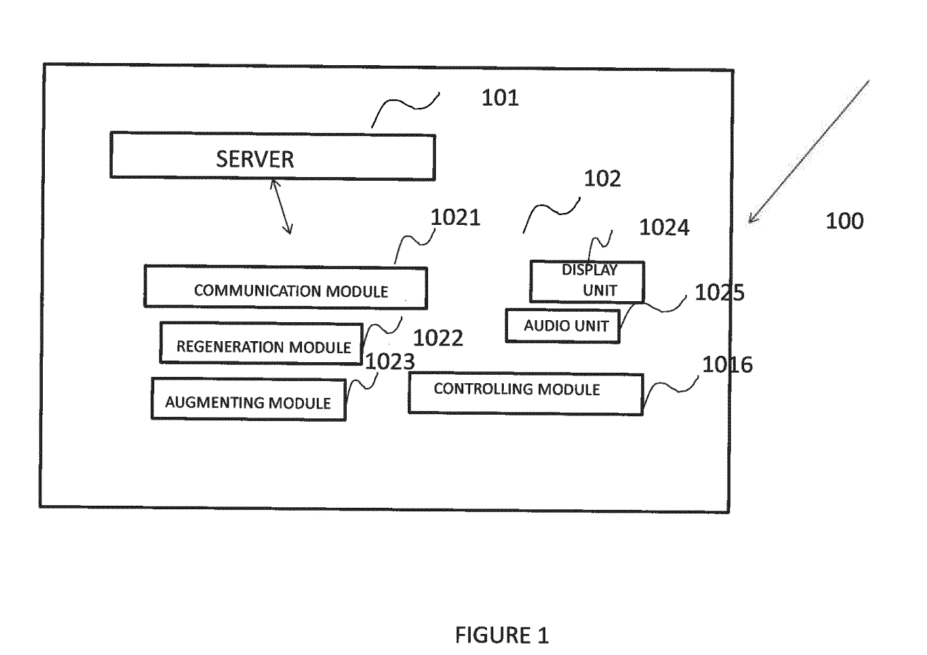

FIG. 1 shows a block diagram of a system for enhancing communication, in accordance with some exemplary embodiments of the subject matter. System 100 includes a server 101 and a plurality of computer devices. For illustration purposes only a single computer device 102 is illustrated, though the system may include a plurality of such computer devices.

The server 101 is configured for receiving a message from any of the plurality of computer devices and to transfer the message to the destination computer device. The message may be part of a live voice communication session or a voice message.

The computer devices 102 is configured for conducting voice communication sessions with one or more of the other computer devices and for receiving and transmitting voice messages to the other communication devices.

The computer device 101 may be a mobile device, a wearable device or a desktop.

The computer device includes a communication module 1021, a regeneration module 1022, an augmenting module 1023, a display unit 1024, an audio module 1025 and a controlling module 1026.

The communication module 1021 is configured for establishing a voice communication session with other computer devices, for handling voice communication sessions and for sensing and receiving voice messages.

The regeneration module 1022 is configured for generating an avatar from meta-data that is received from another computer device.

The augmenting module 1023 is configured for augmenting the avatar that was generated by the regeneration module 1022 in a live video stream that is captured by the computer device during the voice session or when displaying a content of a voice message. When in a communication session the display unit 1024 displays the avatars of all the users that participate in the session on the live video stream that is captured by the computer device 101 during the voice communication session.

The audio unit 1025 is configured for playing audio streams that are received from the other users. The audio may be played as a result of receiving a voice message or during a voice communication session.

The controlling module 1026 is configured for controlling the facial expression of the avatar according to the received audio stream and for controlling the behavior and movements of the avatar according to instructions that are received from the remote user.

The server 101 and the computer device 102 communicate via the internet.

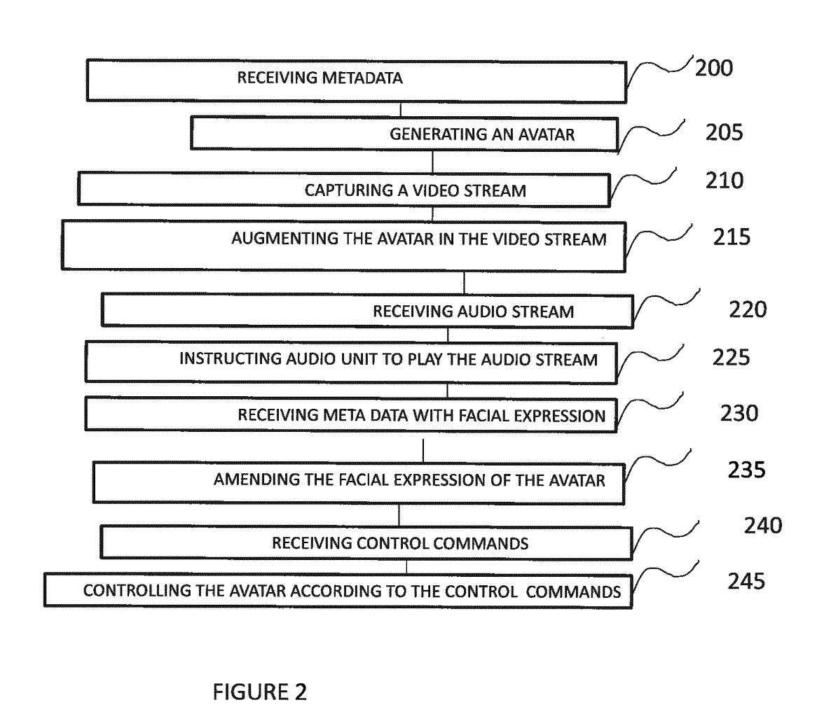

FIG. 2 shows a flowchart of a method for enhancing communication, in accordance with some exemplary embodiments of the subject matter. In some embodiment a live voice communication session is enhanced, in some other embodiments a voice message is enhanced.

At block 200 metadata is received from a remote computer device. The remote computer device may be a Wearable Computer Devices, a mobile device, a laptop or a desktop. In one embodiment, the metadata is received after establishing a voice communication session with the remote computer device. In one other embodiment, the metadata is included in a voice message that is sent from the remote computer device. The metadata includes information for generating an avatar; for example identification of the avatar and identifications of the properties of the avatar. Such properties may be colors, shape, hair, skin, size, etc. In some embodiments, the metadata includes image properties taken from a 2D frontal photo of a face. Such image properties are taken from an image that is inputted by the user of the remote device and which changes the mesh proportions of the 3D model's head and face accordingly. At first, the system detects the head and its different face parts (eyes, eyebrows, nose, mouth, etc) portrayed in the 2D photo by using methods of face detection and face tracking. Next, the system marks the size of the head and face parts detected inside the 2D photo of the face. Then, the system changes the size and proportions of the Avatar's 3D head and face to match the proportions of the face in the 2D frontal image. Then, the frontal image of the face may be projected over the Avatar's 3D head's frontal face to give it a new texture. In the end, the Avatar's 3D head and face have the proportions and texture as seen in the inputted 2D image. In some cases, the image is an image of the user of the remote computer device. In some other embodiments the two dimensional image is sent by the second computer device In addition to the metadata of the avatar. The two dimensional image may be an image of the user of the remote computer device. In some cases, the image is an image of the face of this user or parts of his body.

At block 205, the avatar is generated according to the meta-data. The generating may be done by retrieving the avatar from a data repository and by amending the avatar according to the properties of the metadata. In some embodiments, the avatar is customized in accordance with the received two-dimensional image, by for example projecting on the avatar's three dimensional face texture. In some other embodiments, the avatar is customized according to the image properties that are included in the metadata. Customizing the avatar according to a two dimensional image of the user reflects the resemblance of user of the remote device on the avatar.

At block 210, a live video stream is captured by a camera of the computer device and is displayed to the user of the computer device. The live video stream shows the environment of the computer device. For example, if the device is located in a room, the live video stream is a video of the room. In some embodiments, the live video stream is captured during the voice communication session. In some other embodiments, the live video stream is captured after receiving the voice message from the remote computer device.

At block 215, the avatar is augmented in the live video stream. It should be noted that any augmentation of the 3D model over the device's live video stream may be implemented. Examples of such methods are:

1. Image Tracking—an image that was previously stored in the system is used as the marker to which the augmentation process begins. When the camera is pointed towards a matching image, for example a painting, a poster or a logo, the device places the 3D model over the position of the image and constantly reads the distance between the device and the image to make the 3D model smaller when moving away, larger when moving closer or seen from all sides when user walks around with device in hand; when the image in out of sight, the augmentation is terminated.

2. Markerless Augmented Reality—an image from the live video feed can be saved and stored in the system to be used as the marker for the augmentation to begin. In this method, user can create the marker by himself by a simple selection of an image from the live video feed and without the need of the image to be previously stored and known to the system. For example, any painting or poster or logo, can be stored as the marker for the augmentation process.

3. Using Device's sensors by using the device's gyro, compass and accelerometer information, a user has to hold his device towards the desired surface where he wishes the 3D model to appear over the live video feed. The device determines the new gyro position. When user fmally selects the surface by, for example, tapping over the screen, the new gyro position acts as the starting point from which the 3D model appears and augments. If, for example, device was held parallel to the ground on which user is standing, the 3D model appears in large size, as if “close” to the user. If, for example, device was held 90 degrees to the ground on which user is standing, the 3D model appears in small size, as if “far away”. From this starting point the 3D model may move and animate and provides the illusion of depth by growing larger when moving towards the most parallel part of the gyro or “smaller” when moving towards the most 90 degrees part of the gyro. By adding compass to the equation, the 3D model may move from his starting point all around the user who maintains his initial position. By adding accelerometer to the equation, user's initial starting point is saved. When user physically walks with device in hand, the device can determine the distance the user had gone and his direction, and accordingly display the 3D model's size as larger or smaller. For example, if user is standing in his place and the 3D model is augmented in 45 degrees towards the ground on which the user is currently standing on, and then user takes a step towards the compass direction where model is currently displayed, the device determines a new gyro position for the 3D model and thus making him look larger in size and closer to the parallel part of the gyro.

At block 220, an audio stream is received from the remote computer device. In a case of a voice communication session, the audio stream is received during the session. In a case of voice message, the audio stream is included in the voice message. The audio stream may be a voice recording of the user of the remote device.

At 225, an audio unit of the computer device is instructed to play the audio stream. In a case of a voice communication session, the instructing is performed during the session. In a case of voice message, the instructing is performed as a result of receiving the voice message.

At block 230, metadata that include facial expression of a user of the remote computer device is received. In a case of voice communication session, the metadata is received during the session, for example while receiving the audio stream. In a case of a voice message, the metadata is included in the voice message. The metadata includes commands for changing parts of the face, for example for moving lips or eyes, and also includes timestamps within the audio stream in which the commands has to be performed. The metadata may be generated by the remote computer device by using methods of Face Tracking where user's real head and face parts are first detected (head shape, eyes, eyebrows, nose, mouth, etc.) through the device's live camera feed. When the user begins moving in front of the camera, each of his facial parts movement during the video feed is recorded into a sequence. This sequence is implemented over the avatar's 3D head and face parts (eyes, eyebrows, nose, mouth, etc.) which will now move accordingly. For example, if user lifted his eyebrows during the live video feed, this movement data of eyebrows affects the 3D eyebrows of the avatar's 3D head to animate accordingly.

At block 235, the facial expression of the avatar is amended in accordance with the metadata that includes the facial expression. For example, the lips may be moved. In some other embodiments, the facial expression is amended in accordance with an audio stream by using methods of audio analysis to determine different phonetics in the spoken audio stream recorded by the user. According to some embodiments each phonetic is associated with a different animation or facial expression that the system has associated before the audio analysis. During the audio streaming, the animations or facial expressions are played according to the matching phonetics. For example, if user spoke the word “oil” during the audio recording, the phonetics of the word is analyzed and accordingly animates the 3D mouth of the avatar with the “0” shape of the lips. In this manner, the way the user's real lips have moved during his audio recording is imitated through animations of the avatar's 3D lips. The analyzing of the phonetics of the word may be done, for example, in accordance with an audio stream (BM1) by using methods of Automatic Speech Recoginition (ASR) to determine pauses in speech or to determine different phonetics in the spoken audio stream spoken by the user. Each phonetic is associated with a different facial animation or lip-synchronization which the system has associated before the audio analysis.

At block 240, a message including control commands is received from the computer device of the generator of the avatar.

At block 245, the avatar is controlled according to the control commands. The control commands may include commands relating to movements of the avatar, for example, causing the avatar to jump, walk or run.

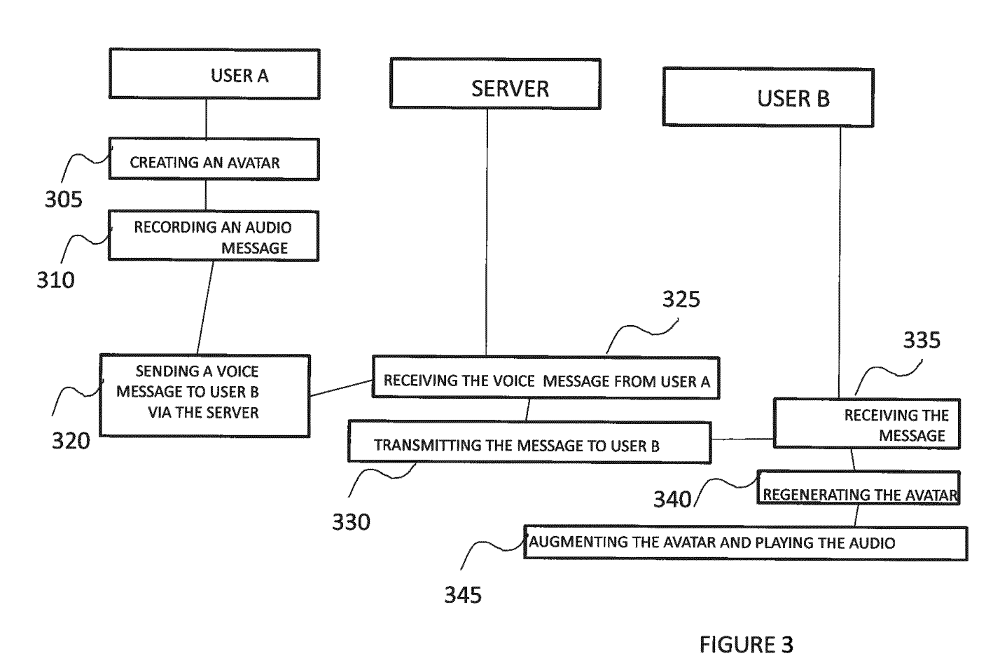

FIG. 3 shows a flowchart of a scenario for enhancing a voice message, in accordance with some exemplary embodiments of the disclosed subject matter.

According to some embodiments, a user may send a voice message that may include, in addition to a recording of his voice, metadata that enables the destination user to watch an avatar. The avatar may resemble the sender of the message and may be pre-configured at the sender computer device to move and/or to change facial expression when the voice recording is played by the destination user of the message. Referring now to the drawing:

At block 305, the sender of the voice message selects an avatar from a data repository. As a result, the metadata that identifies the avatar is retrieved from the data repository. The metadata is used by the computer device of the destination user for regenerating the avatar. In some cases, the sender customizes the avatar to resemble the user. In some embodiments, the image of the sender is projected on the avatar to customize the avatar to resemble the user.

At block 310, the sender records an audio message. In some cases, the facial changes of the user are tracked while recording the message in order to reconstruct the facial expression when the audio is played at the computer device of the destination user.

At block 315, a voice message is sent user 13 via the server. The voice message includes the metadata that is required for regenerating the customized avatar and the audio recording. In some cases the voice message includes the two dimensional image of the user.

At block 325, the server receives the voice message from the sender.

At block 330, the server sends the voice message to the destination user.

At block 335, the destination user receives the message from the sender.

At block 340, the computer device of the destination user regenerates the avatar according to the metadata, the audio recording and the image.

At block 345 the avatar is augmented on a live stream video, the audio is played and the facial expression of the avatar is changed with referring to the audio.

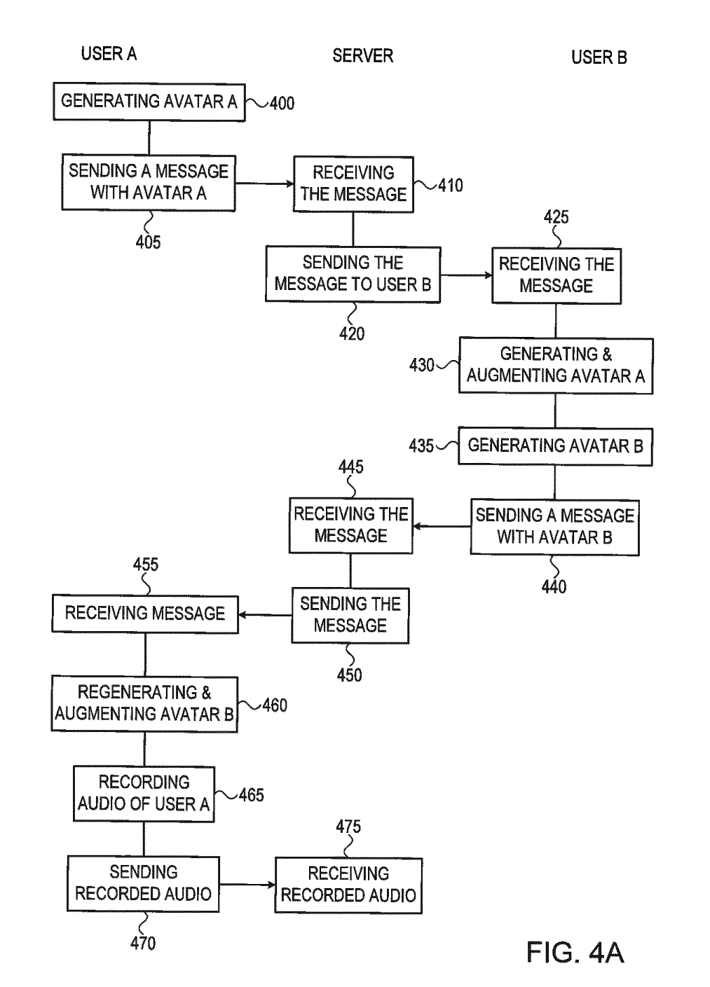

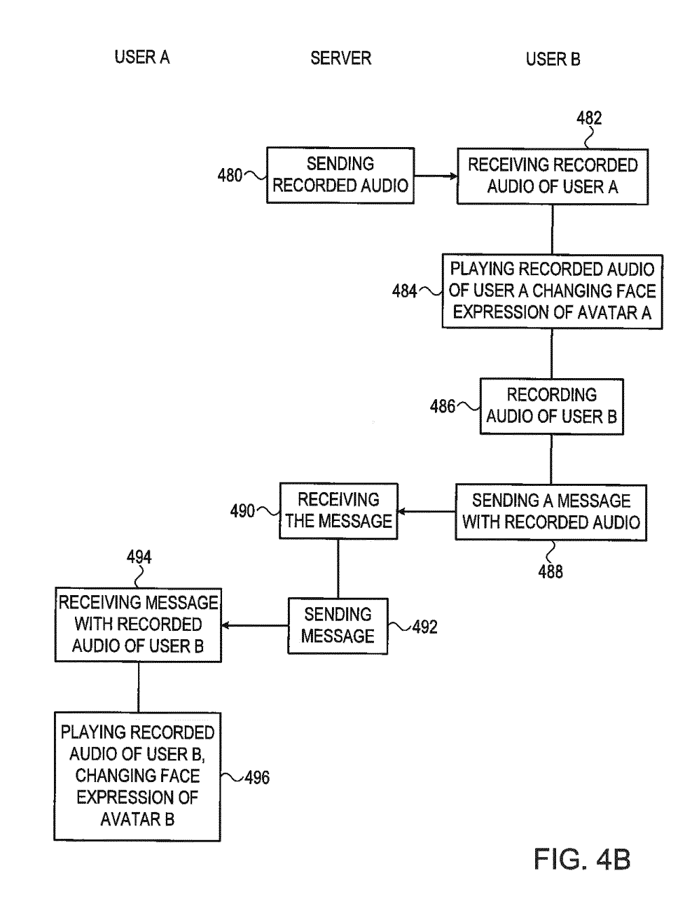

FIGS. 4A and 4B show a flowchart of a scenario for enhancing a voice call, in accordance with some exemplary embodiments of the disclosed subject matter. In some embodiments, a voice call session is generated within two or more participants. Each participant of the voice call may send metadata of a customized avatar and may remotely control the avatar during the voice communication session. The avatars may be augmented in a live video of each participant of the voice call session; thus, a computer device of each participant may display a live video of the environment of this computer device augmented with the avatars that represent the participants of the call.

Referring now to the drawing:

All the blocks of the drawing are performed within a voice communication session.

Blocks 400,405,410 and 420 describe the generating of avatar A by user A and the sending of a message with avatar A to user B.

At block 400, avatar A is generated by user A. The avatar may by customized by this user to reflect the image of the user.

At block 405, a message comprising the avatar A is sent to the server.

At block, 410 the server receives the message.

At block, 420 the server sends the message to user B.

Blocks 435 and 430 describe the receiving of the message with avatar A and the regenerating of the avatar A by user B.

At block 425, user B receives the message.

At block 430, user B regenerates the avatar of user A and augments this avatar in a live video stream that is captured by a camera of his computer device.

Blocks 435,440,445 and 450 describe the generating of avatar B by user B and the sending of a message with avatar B to user A.

At block 435, user B generates avatar B. Avatar B may by customized by this user to reflect the image of the user.

At block 440, a message comprising the avatar B is sent to the server.

At block 445, the server receives the message from user B.

At block 450, the server sends the message of user B to user A.

Blocks 455 and 460 describe the receiving of the message with avatar B and the regenerating of the avatar B by user A.

At block 455, user A receives the message from user B.

At block 460 user A regenerates the avatar of user B and augments this avatar in a live video stream that is captured by a camera of his computer device.

Blocks 465,470, 475 and 480 describe the generating of a recording by user A and the sending of the recording to user B.

At block 465, user A records himself.

At block 470, user A sends a message with the recorded audio.

At block 475, the server receives the message with the recorded audio from user

At block 480, the server sends the recorded audio to user B.

Blocks 482 and 484 describe the receiving of the recording of user A and the playing of the recording by the computer device of user B.

At block 482, User B receives the message with the recorded audio of user A.

At block 484, the recorded audio of user A is played by the computer device of user B while changing facial expression of avatar A in accordance with playing the audio.

Blocks 486,488, 490 and 492 describe the generating of a recording by user B and the sending of the recording to user A.

At block 486, user B records audio.

At block 488, user B sends a message with the recorded audio.

At block 490, the server receives the message from user B.

At block 492, the server sends the recorded audio to user A.

Blocks 494 and 496 describe the receiving of the recording of user B and the playing of the recording by the computer device of user A.

At block 494, user A receives the message with the recorded audio of user B.

At block 496 the recorded audio of user B is played by the computer device of user A while changing facial expression of avatar B in accordance with playing the audio.

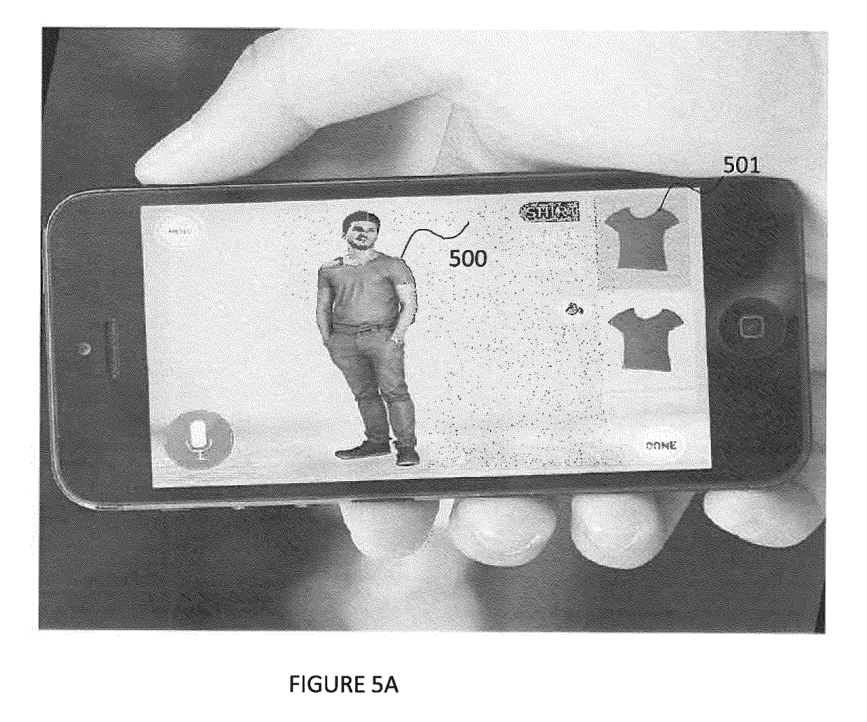

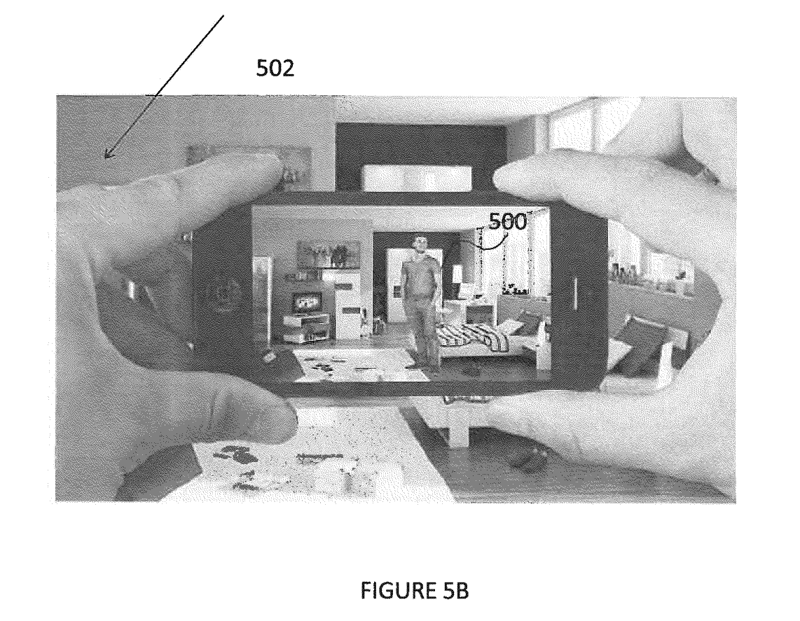

FIGS. 5A and 5B show an exemplary screen capture of an enhanced voice communication in accordance with some exemplary embodiments of the disclosed subject matter. FIG. 5A shows an avatar 500 that is generated by a computer device A of user A. The avatar 500 is customized to resemble user A. The avatar 500 is customized, for example, with clothing items 501. The avatar 500 is sent from the computer device A of user A to the computer device B of user B at the beginning of the voice session.

FIG. 5B shows the avatar A 500 embedded in a video of the environment 502 of user B. The video of the environment 502 with the avatar 500 is displayed on the computer device B of User B during the communication session with user A.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that ao can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming so language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for enhancing communication, comprising: at a first computer device having at least one processor and memory:
generating an avatar according to metadata; said metadata being received from a second computer device via the internet;
augmenting said avatar in a live video stream; said live video stream being captured by said first computer device; and
instructing an audio unit of said first computer device to play an audio stream; wherein said audio stream being received from said second computer device via the internet; wherein said audio stream comprises a recording of a user of said second computer device; wherein said generating, said augmenting and said instructing being within a voice communication session between said first computer device and said second computer device or wherein said generating, said augmenting and said instructing being as a result of receiving a voice message from said second computer device.

2. The method of claim 1, wherein said first computer device and said second computer device being a mobile device or a Wearable Computer Device.

3. The method of claim 1, further comprises amending facial expression of said avatar in accordance with said audio stream to thereby reflect facial expression of said user.

4. The method of claim 1, further comprises receiving second metadata and amending facial expression of said avatar in accordance with said second metadata wherein said second metadata comprises facials expression of said user of said second computer device; said facial expression being captured by said second computer device; thereby reflecting facial expression of said user.

5. The method of claim 1, wherein said avatar being a three dimensional avatar and further comprising receiving a two dimensional image from said second computer device and wherein said generating said avatar comprises embedding said two dimensional image in said avatar.

6. The method of claim 6, wherein said two dimensional image being an image of a user of said second computer device; thereby reflecting said image of said user in said avatar.

7. A method for enhancing communication, comprising: at a first computer device having at least one processor and memory:
generating an avatar according to metadata; said metadata being received from a second computer device via the internet;
instructing an audio unit of said first computer device to play an audio stream; said audio stream being a recording of a user of said second computer device; said audio stream being received via the internet from said second computer device; and
amending facial expression of said avatar in accordance with said audio stream, or amending facial expression of said avatar in accordance with second metadata, said second metadata being received from said second computer device via the internet, said second metadata comprises facials expression of a user of said second computer device during said recording; said facial expression being captured by said second computer device; wherein said generating, said instructing and said amending being within a voice communication session between said first computer device and said second computer device or wherein said generating, said instructing and said amending being as a result of receiving a voice message from said second computer device.

8. The method of claim 7, further comprises manipulating said avatar within said communication session; wherein said manipulating being in accordance with instructions said instructions being received from said second computer device within said communication session.

9. The method of claim 1, wherein said voice communication session and said voice message excluding a video stream.

10. The method of claim 7, wherein said voice communication session and said voice message excluding a video stream.

11. A non-transitory computer-readable storage medium storing instructions, the instructions when executed by a processor in a social networking system, causes the processor to:
generating an avatar according to metadata; said metadata being received from a second computer device via the internet;
augmenting said avatar in a live video stream; said live video stream being captured by said first computer device; and instructing an audio unit of said first computer device to play an audio stream; wherein said audio stream being received from said second computer device via the internet; wherein said audio stream comprises a recording of a user of said second computer device; wherein said generating, said augmenting and said instructing being within a voice communication session between said first computer device and said second computer device or wherein said generating, said augmenting and said instructing being as a result of receiving a voice message from said second computer device.
